(19) United States
(12) Patent Application Publication
(10) Pub. No.: US 2007/0286055 A1
(43) Pub. Date: Dec. 13, 2007

(54) Optical pickup apparatus and information recording/reproduction apparatus

(75) Inventor: Taiichiro Yano, Mihara-shi (JP)

Correspondence Address: MORRISON & FOERSTER LLP, 1650 TYSONS BOULEVARD, SUITE 400, MCLEAN, VA, 22102, US

(73) Assignee: SHARP KABUSHIKI KAISHA, Osaka-shi (JP)

(21) Appl. No.: 11/790,596

(22) Filed: Apr. 26, 2007

(30) Foreign Application Priority Data
Jun. 7, 2006 (JP) 2006-159103

(51) Int. Cl. G11B 7/00

(52) U.S. Cl. 369/112.29

(57) ABSTRACT

An optical pickup apparatus and an information recording/reproduction apparatus that can reduce flare light generated by an objective lens and reduce stray light are provided. An erecting mirror is provided on an optical path between a light source and an objective lens. An incident face on the erecting mirror is provided with a wavelength selective film having a first region that reflects a light beam having a first wavelength emitted from a first semiconductor laser device and that transmits a light beam having a second wavelength emitted from a second semiconductor laser device, and a second region that reflects light beams emitted from the first and the second semiconductor laser devices.

### CROSS-REFERENCE TO RELATED APPLICATION

This application claims priority to Japanese Patent Application No. 2006-159103, which was filed on Jun. 7, 2006 the contents of which, are incorporated herein by reference, in their entirety.

### BACKGROUND OF THE INVENTION

1. Field of the Invention

The present invention relates to an optical pickup apparatus that is preferably used when at least either a reading process of information recoded in an optical recording medium or a recording process of information onto the optical recording medium is performed, and an information recording/reproduction apparatus.

2. Description of the Related Art

Optical pickup apparatuses are used for reading and recording information from/onto optical disk recording media (hereinafter, simply referred to as “optical recording media”) such as compact disks (abbreviated as “CDs”) and digital versatile disks (abbreviated as “DVDs”). The optical pickup apparatuses read and record information from/onto optical recording media by irradiating the optical recording media with a light beam emitted from a light source such as a semiconductor laser device, and detecting the light reflected from the optical recording media with a photodetector.

The thickness of a CD is 1.2 mm, and the thickness of a DVD is 0.6 mm, and thus the focal distance is different therebetween. Accordingly, in order to read and record information from/onto a CD and a DVD, two semiconductor laser devices that emit light beams having mutually different oscillation wavelengths are used as the light source, and thus it is necessary to use, as an objective lens, a bifocal lens having mutually different focal distances for light beams that are emitted respectively from the two semiconductor laser devices. In order to focus a light beam emitted from the semiconductor laser device on an information recording surface of a CD, it is necessary that the numerical aperture (abbreviated as the “NA”) of the objective lens is 0.45. In order to focus a light beam emitted from the semiconductor laser device on an information recording surface of a DVD, it is necessary that the NA of the objective lens is 0.6.

Equation 1 below shows the relationship between the diameter Φ of a light beam emitted from the semiconductor laser device and entering the objective lens (hereinafter, may be referred to as the “incident beam diameter”), and the NA of the objective lens, taking the focal distance of the objective lens as “f”.

Φ=2f×NA Equation 1

Thus, when using the objective lens having a predetermined focal distance “f”, in order to obtain a predetermined NA, it is necessary that light beams having different beam diameters Φ enter the objective lens, depending on the optical recording media, which have different thicknesses.

FIG. 11 is a view showing a simplified optical path of a light beam emitted toward a DVD 1 in a conventional optical pickup apparatus. FIG. 12 is a view showing a simplified optical path of a light beam reflected by the DVD 1 in the conventional optical pickup apparatus. The optical path of a light beam emitted from a semiconductor laser device is changed by an erecting mirror 2, and then the light beam travels via an objective lens 3 in which the NA has been adjusted such that the light beam emitted from the semiconductor laser device is focused on an information recording surface of the DVD 1, and is focused on the information recording surface of the DVD 1. The light beam reflected by the information recording surface of the DVD 1 travels via the objective lens 3, the optical path of the light beam is changed by the erecting mirror 2, and then the light beam enters a photodetector (not shown).

In the optical pickup apparatus, when using the objective lens 3 in which the NA has been adjusted such that a light beam emitted from the semiconductor laser device is focused on the information recording surface of the DVD 1 as described above, it is not necessary to adjust the incident beam diameter Φ in order to obtain a necessary NA.

On the other hand, in order to read and record information from/onto a CD using the objective lens 3 in which the NA has been adjusted such that a light beam emitted from the semiconductor laser device is focused on the information recording surface of the DVD 1, it is necessary to adjust the NA such that the light beam is focused on an information recording surface of the CD, by narrowing the incident beam diameter Φ on the objective lens of the light beam emitted from the semiconductor laser device.

Examples of methods for narrowing the incident beam diameter Φ include a method for narrowing the incident beam diameter Φ by a diffracting action of diffraction grooves, using a diffraction-type objective lens having the diffraction grooves, and a method for narrowing the incident beam diameter Φ, using a filter provided in front of an objective lens.

FIG. 13 is a view showing a simplified optical path of a light beam emitted toward a CD 6 in a conventional optical pickup apparatus provided with a diffraction-type objective lens 5. FIG. 14 is a view showing a simplified optical path of a light beam reflected by the CD 6 in the conventional optical pickup apparatus provided with the diffraction-type objective lens 5. The optical path of a light beam emitted from a semiconductor laser device is changed by the erecting mirror 2, and then the light beam is diffracted by a diffracting action of the diffraction grooves formed on the diffraction-type objective lens 5 when traveling via the diffraction-type objective lens 5. A part of light diffracted by the diffraction-type objective lens 5 is scattered as flare light 7, which is unwanted light for reading or recording information from/onto the CD 6.

By scattering a light beam entering the diffraction-type objective lens 5 as the flare light 7 in this manner, the beam diameter Φ of the light beam entering the diffraction-type objective lens 5 is narrowed, and thus the NA is adjusted to a predetermined value. Light that has traveled via the diffraction-type objective lens 5 and then diffracted is reflected by the information recording surface of the CD 6, travels on the same path as the onward path, and then enters a photodetector (not shown).

FIG. 15 is a view showing a simplified optical path of a light beam emitted toward the CD 6 in a conventional optical pickup apparatus provided with a filter 8. FIG. 16 is a view showing a simplified optical path of a light beam reflected by the CD 6 in the conventional optical pickup apparatus provided with the filter 8. The filter 8 is provided on the optical path between the erecting mirror 2 and the objective lens 3. The optical path of a light beam emitted from a semiconductor laser device is changed by the erecting mirror 2, and then the light beam enters the filter 8. Of the light beam entering the filter 8, the light beam on the outer circumferential portion, from which flare light is generated, is blocked by the filter 8. Accordingly, the beam diameter Φ of the light beam entering the objective lens 3 is narrowed, and thus the NA is adjusted to a predetermined value.

The above-described techniques for narrowing the incident beam diameter Φ using the diffraction-type objective lens 5 provided with the diffraction grooves or the filter 8 have been disclosed in Japanese Unexamined Patent Publications JP-A 10-222866 (1998), JP-A 08-55363 (1996) and JP-A 2003-45069. In an optical pickup apparatus in JP-A 10-222866, a filter that has a circular aperture formed through the thickness direction and that is dichroic-coated at portions other than the circular aperture is fixed on a support member of an objective lens. A laser beam having a wavelength of 635 nm is transmitted through the dichroic-coated portion of the filter and enters the objective lens. Of a laser beam having a wavelength of 780 nm, the outer circumferential portion of the beam is reflected by the dichroic-coated portion, and thus the beam diameter is limited to the diameter of the circular aperture of the filter.

In an optical head of JP-A 08-55363, aperture limitation with respect to a light beam emitted from a semiconductor laser of a laser detector-integrated module is performed using a movable aperture-limiting plate that is integrally attached to an actuator of an objective lens. More specifically, when reproducing a high-density optical disk, reproduction is performed using the whole aperture of the objective lens, and when reproducing an optical disk with a base material having a thickness of 1.2 mm, aperture limitation is performed by moving the movable aperture-limiting plate into a light beam such that the light is focused optimally for reproducing the optical disk.

In an optical pickup apparatus of JP-A 2003-45069, a dichroic filter for limiting the aperture with respect to an objective lens of a laser light that easily gives an influence of a noise to a focus error signal is provided between a semiconductor laser device and the objective lens, and thus light does not enter an outer region of the objective lens, so that a noise generated due to the lens characteristics is eliminated. Accordingly, the positions of the objective lens and the optical disk can be controlled without an error.

In a case where the beam diameter Φ of a light beam entering the objective lens 3 is narrowed, by providing the filter 8 on the optical path between the erecting mirror 2 and the objective lens 3, and blocking the light beam on the outer circumferential portion, of the light beam entering the filter 8 as in the conventional techniques, the filter 8 is necessary as an additional component. Thus, the production cost of the optical pickup apparatus is increased, and adjustment of the position of the filter 8 is complicated. Furthermore, a light beam emitted from the semiconductor laser device is reflected by one surface of the filter 8 on the side of the erecting mirror 2 and enters a photodetector (not shown) as stray light other than signal light, and thus an error is caused in a detection signal for reading and recording information from/onto the optical recording medium.

Furthermore, in a case where the beam diameter Φ of a light beam entering the diffraction-type objective lens 5 is narrowed by scattering the light beam entering the diffraction-type objective lens 5 as the flare light 7 as in the conventional techniques, the flare light 7 is inevitably generated by the diffraction-type objective lens 5. This flare light 7 is reflected by the optical recording medium and enters a photodetector (not shown) as stray light other than signal light. Thus, an error is caused in a detection signal for reading and recording information from/onto the optical recording medium.

### SUMMARY OF THE INVENTION

It is an object of the invention to provide an optical pickup apparatus that can reduce flare light generated by an objective lens and reduce stray light, and an information recording/reproduction apparatus.

The invention provides an optical pickup apparatus, comprising:

a light source for emitting light beams having oscillation wavelengths different from each other;

an objective lens for focusing each light beam emitted from the light source on an optical recording medium corresponding to the light beam;

a wavelength selective optical element provided on an optical path between the light source and the objective lens, for reflecting or transmitting an incident light beam depending on an oscillation wavelength thereof, and for guiding the reflected light beam to the objective lens; and

a photodetector for detecting a light beam that is emitted from the light source and reflected by an information recording surface of the optical recording medium,

wherein the wavelength selective optical element has a first region that reflects a light beam having the first oscillation wavelength emitted from the light source and that transmits a light beam having the second oscillation wavelength, and a second region that reflects the light beams emitted from the light source.

According to the invention, each light beam emitted from the light source is focused by the objective lens on the optical recording medium corresponding to the light beam. The optical path between the light source and the objective lens is provided with the wavelength selective optical element that reflects or transmits an incident light beam depending on the oscillation wavelength thereof and that guides the reflected light beam to the objective lens. The wavelength selective optical element has a first region that reflects a light beam having a first oscillation wavelength emitted from the light source and that transmits a light beam having a second oscillation wavelength, and a second region that reflects the light beams emitted from the light source.

The light beam having the first oscillation wavelength emitted from the light source is reflected and guided to the objective lens when the light beam enters the first region on the wavelength selective optical element, and is reflected and guided to the objective lens when the light beam enters the second region on the wavelength selective optical element. The light beam having the second oscillation wavelength emitted from the light source is transmitted when the light beam enters the first region on the wavelength selective optical element, and is reflected and guided to the objective lens when the light beam enters the second region on the wavelength selective optical element. The light beam guided to the objective lens is focused on the information recording surface of the optical recording medium. The light beam focused on the information recording surface of the optical recording medium is detected by the photodetector.

When the optical path between the light source and the objective lens is provided with the wavelength selective optical element as described above, it is possible to guide only the light beam entering the second region to the objective lens by reflecting the light beam, of the light beam having the second oscillation wavelength which light beam is emitted from the light source and enters the wavelength selective optical element. In other words, by providing the wavelength selective optical element, the beam diameter of the light beam having the second oscillation wavelength emitted from the light source can be limited to a predetermined size, before the light beam having the second oscillation wavelength enters the objective lens, and thus the light beam having the second oscillation wavelength whose beam diameter has been limited to the predetermined size can enter the objective lens.

Accordingly, it is possible to adjust the numerical aperture of the objective lens to a numerical aperture appropriate for focusing the light beam having the second oscillation wavelength on the information recording surface of the optical recording medium. Thus, it is possible to reduce the amount of flare light generated when the light beam having the second oscillation wavelength travels via the objective lens, compared with a case in which the light beam having the second oscillation wavelength whose beam diameter has not been limited to a predetermined size enters the objective lens.

Accordingly, flare light generated at the objective lens is less reflected by the optical recording medium to enter the photodetector as stray light other than signal light. Thus, it is possible to suppress an error caused by flare light, in a detection signal for reading and recording information from/onto the optical recording medium, compared with a case in which the light beam having the second oscillation wavelength whose beam diameter has not been limited to a predetermined size enters the objective lens.

Furthermore, in the invention, it is preferable that positions of the first and the second regions on the wavelength selective optical element are set based on a movable range of the objective lens in a direction that corresponds to a track direction of the optical recording medium, and a predetermined reference position of the objective lens.

According to the invention, the positions of the first and the second regions on the wavelength selective optical element are set based on the movable range of the objective lens in a direction that corresponds to the track direction of the optical recording medium, and a predetermined reference position of the objective lens. Accordingly, the beam diameter in the track direction of the light beam can be limited to the maximum size within the range in which the objective lens can be moved by an external force from the predetermined reference position in the direction that corresponds to the track direction of the optical recording medium, before the light beam emitted from the light source enters the objective lens. Thus, the light beam whose beam diameter has been limited to the maximum size within the range in which the objective lens can be moved in the direction that corresponds to the track direction can enter the objective lens.

The light beam whose beam diameter in the track direction has been limited can enter the objective lens in this manner, and thus it is possible to reduce the amount of flare light generated when the light beam travels via the objective lens, compared with a case in which the light beam whose beam diameter in the track direction has not been limited enters the objective lens.

Accordingly, flare light generated at the objective lens is even less reflected by the optical recording medium to enter the photodetector as stray light other than signal light. Thus, it is possible to further suppress an error caused by flare light, in a detection signal for reading and recording information from/onto the optical recording medium, compared with a case in which the light beam whose beam diameter in the track direction has not been limited enters the objective lens.

Furthermore, in the invention, it is preferable that the optical pickup apparatus further comprises an erecting mirror which a light beam emitted from the light source enters,

wherein the wavelength selective optical element is constituted by a wavelength selective film disposed on a surface of the erecting mirror, for reflecting or transmitting an incident light beam depending on an oscillation wavelength thereof.

In the invention, it is preferable that the first region is disposed around edges of the surface of the erecting mirror.

In the invention, it is preferable that the first region is disposed to surround the second region.

According to the invention, the wavelength selective optical element can be realized as a wavelength selective film that is disposed on a surface of the erecting mirror which a light beam emitted from the light source enters, and that reflects or transmits an incident light beam depending on an oscillation wavelength thereof. Thus, using the wavelength selective film that is disposed on the surface of the erecting mirror, the light beam emitted from the light source can be reflected or transmitted depending on the oscillation wavelength thereof, so that, for example, the beam diameter of the light beam having the second oscillation wavelength emitted from the light source can be limited to a predetermined size before the light beam having the second oscillation wavelength enters the objective lens.

Accordingly, it is possible to prevent the number of optical components from being increased and to prevent the production cost of the optical pickup apparatus from being increased, compared with the conventional techniques in which an optical component such as a filter used only for limiting the beam diameter of the light beam having the second oscillation wavelength to a predetermined size is provided in addition to the erecting mirror.

Furthermore, the invention provides an information recording/reproduction apparatus on which the optical pickup apparatus is mounted.

According to the invention, it is possible to realize an information recording/reproduction apparatus on which the optical pickup apparatus is mounted, that is, an information recording/reproduction apparatus that can suppress an error caused by stray light, in a detection signal for reading and recording information from/onto the optical recording medium.

### BRIEF DESCRIPTION OF THE DRAWINGS

Other and further objects, features, and advantages of the invention will be more explicit from the following detailed description taken with reference to the drawings wherein:

FIG. 1 is a view showing the configuration of an optical pickup apparatus according to one embodiment of the invention;

FIG. 2 is an end face view showing an incident face on the erecting mirror;

FIG. 3 is a view showing a simplified optical path of a light beam emitted toward a CD;

FIG. 4 is a view showing a simplified optical path of a light beam reflected by the CD;

FIG. 5 is a view showing a state in which a light beam traveled via the erecting mirror and the objective lens is focused on the optical recording medium;

FIG. 6 is an end face view of FIG. 5, viewed from the direction in which a light beam directed to the optical recording medium enters the erecting mirror;

FIG. 7 is a view showing an incident beam region, the one side effective beam region, and the other side effective beam region;

FIG. 8 is an end face view showing the incident face on the erecting mirror in an optical pickup apparatus according to another embodiment of the invention;

FIG. 9 is an end face view showing the incident face on the erecting mirror in an optical pickup apparatus according to still another embodiment of the invention;

FIG. 10 is a block diagram showing the configuration of an information recording/reproduction apparatus;

FIG. 11 is a view showing a simplified optical path of a light beam emitted toward a DVD in a conventional optical pickup apparatus;

FIG. 12 is a view showing a simplified optical path of a light beam reflected by the DVD in the conventional optical pickup apparatus;

FIG. 13 is a view showing a simplified optical path of a light beam emitted toward a CD in a conventional optical pickup apparatus provided with a diffraction-type objective lens;

FIG. 14 is a view showing a simplified optical path of a light beam reflected by the CD in the conventional optical pickup apparatus provided with the diffraction-type objective lens;

FIG. 15 is a view showing a simplified optical path of a light beam emitted toward the CD in a conventional optical pickup apparatus provided with a filter; and

FIG. 16 is a view showing a simplified optical path of a light beam reflected by the CD in the conventional optical pickup apparatus provided with the filter.

### DETAILED DESCRIPTION

Now referring to the drawings, preferred embodiments of the invention are described below.

Hereinafter, a plurality of embodiments of the invention are described. In the following description, a component corresponding to an already described component may be denoted by the same reference number and the description thereof may not be repeated. In a case where only a portion of a component is described, the other portions of the component are the same as those that have been already described.

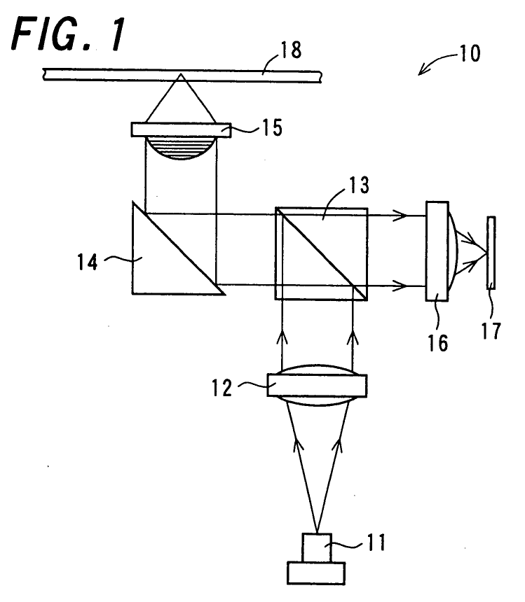

FIG. 1 is a view showing the configuration of an optical pickup apparatus 10 according to one embodiment of the invention. The optical pickup apparatus 10 irradiates an optical disk recording medium (hereinafter, simply referred to as an “optical recording medium”) 18 such as a compact disk (abbreviated as a “CD”) and a digital versatile disk (abbreviated as a “DVD”) with a light beam, thereby performing at least either one of a process of reading information of the optical recording medium 18 and a process of recording information onto the optical recording medium 18. Examples of the optical recording medium 18 include CD, CD-R (Compact Disk-Recordable), CD-RW (Compact Disk-Rewritable), DVD, DVD-R (Digital Versatile Disk-Recordable), and DVD-RAM (Digital Versatile Disk-Random Access Memory).

The optical pickup apparatus 10 includes a light source 11, a collimator lens 12, a prism 13, an erecting mirror 14, an objective lens 15, a focusing lens 16, and a photodetector 17. The light source 11 includes a first semiconductor laser device and a second semiconductor laser device. The first semiconductor laser device emits a laser beam having an oscillation wavelength of a first wavelength such as 650 nm in the red wavelength range (hereinafter, may be referred to as a “first laser beam”), and is used, for example, for reading information recorded on an information recording surface of a DVD. The second semiconductor laser device emits a laser beam having an oscillation wavelength of a second wavelength such as 780 nm in the infrared wavelength range (hereinafter, may be referred to as a “second laser beam”), and is used, for example, for reading information recorded on an information recording surface of a CD and recording information onto the information recording surface of the CD.

The collimator lens 12 changes an incident laser beam into a parallel beam. The prism 13 separates a laser beam directed to the optical recording medium 18 and a laser beam reflected by the optical recording medium 18. The erecting mirror 14 is provided on the optical path between the light source 11 and the objective lens 15. One surface of the erecting mirror 14 is provided with a wavelength selective film serving as a wavelength selective optical element. The wavelength selective film reflects or transmits an incident laser beam that has traveled via the prism 13, depending on the oscillation wavelength thereof. Furthermore, the erecting mirror 14 guides an incident laser beam that has traveled via the prism 13, to the objective lens 15 by bending the optical path of the laser beam by 90 degrees, and guides an incident laser beam that has traveled via the objective lens 15, to the prism 13 by bending the optical path of the laser beam by 90 degrees.

The objective lens 15 is realized as a diffraction-type objective lens having diffraction grooves. The objective lens 15 focuses a laser beam bent by the erecting mirror 14 on the optical recording medium 18 corresponding to the laser beam. The focusing lens 16 guides an incident laser beam that has traveled via the prism 13, to the photodetector 17. The photodetector 17 is realized as a photodiode, for example. The photodetector 17 detects a pit signal of the optical recording medium 18, by receiving a laser beam reflected by the optical recording medium 18, and photoelectrically converting the beam into an electric signal based on the received laser beam. In the following description, the first laser beam emitted from the first semiconductor laser device and the second laser beam emitted from the second semiconductor laser device may be simply referred to as “light beams”.

The light beams emitted from the first and the second semiconductor laser devices enter the collimator lens 12. The light beams entering the collimator lens 12 are converted into parallel beams and enter the prism 13. The optical paths of the light beams entering the prism 13 are bent by 90 degrees, and the light beams enter the erecting mirror 14. The light beams entering the erecting mirror 14 are reflected or transmitted, depending on the oscillation wavelength thereof. The light beam reflected by the erecting mirror 14 such that the optical path thereof is bent by 90 degrees enters the objective lens 15. The light beam entering the objective lens 15 is focused on the information recording surface of the optical recording medium 18 corresponding to the light beam.

The light beam reflected by the optical recording medium 18 travels via the objective lens 15 and the erecting mirror 14, and then enters the prism 13. The light beam entering the prism 13 is transmitted through the prism 13, enters the focusing lens 16, and is then guided by the focusing lens 16 to a predetermined region on the photodetector 17. The optical pickup apparatus 10 performs at least either one of a process of reading information of the optical recording medium 18 and a process of recording information onto the optical recording medium 18, based on a signal detected by the photodetector 17.

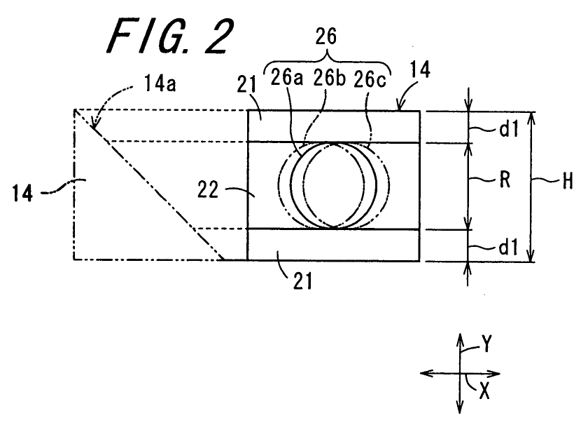

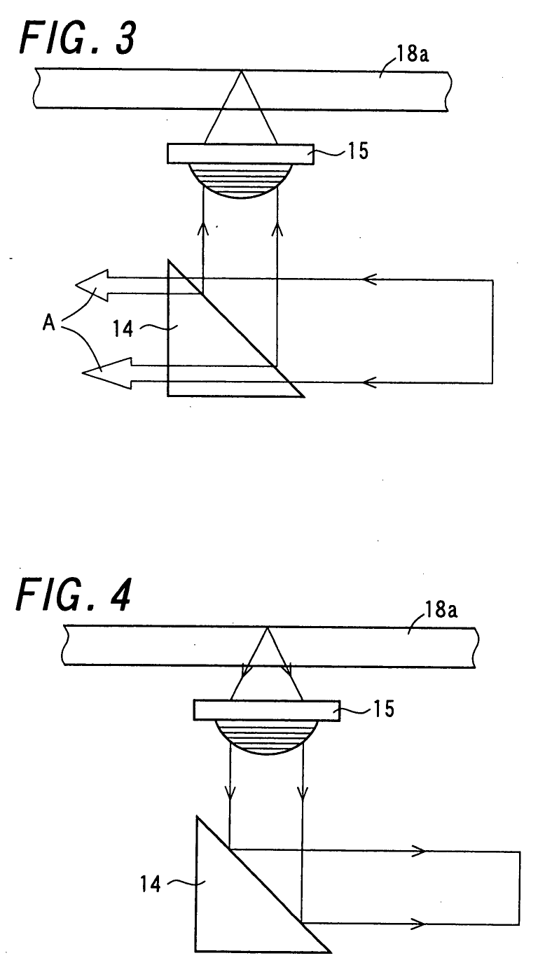

FIG. 2 is an end face view showing an incident face 14a on the erecting mirror 14. FIG. 3 is a view showing a simplified optical path of a light beam emitted toward a CD 18a. FIG. 4 is a view showing a simplified optical path of a light beam reflected by the CD 18a. For convenience, FIGS. 3 and 4 show only the erecting mirror 14, the objective lens 15, and the CD 18a serving as an optical recording medium.

The erecting mirror 14 is in the shape of a triangular prism. The erecting mirror 14 has the incident face 14a which light beams emitted from the first and the second semiconductor laser devices and traveled via the prism 13 enter. In this embodiment, on the incident face 14a, a direction which is perpendicular to a direction in which a light beam traveled via the prism 13 enters the incident face 14a (hereinafter, may be referred to as an “incident direction”) and which is vertical to a height direction of the erecting mirror 14, is taken as an X direction, and the height direction of the erecting mirror 14 is taken as a Y direction. In FIG. 2, the X direction is indicated as X, and the Y direction is indicated as Y. The incident face 14a on the erecting mirror 14 is formed in the shape of a rectangle that extends in the X direction, viewed from one side in the incident direction.

The incident face 14a forming one surface of the erecting mirror 14 is provided with the wavelength selective film. The wavelength selective film has first regions 21 that are constituted by a thin film having a function of reflecting a light beam emitted from the first semiconductor laser device and traveled via the prism 13, and of transmitting a light beam emitted from the second semiconductor laser device and traveled via the prism 13, and a second region 22 that is constituted by a thin film having a function of reflecting light beams emitted from the first and the second semiconductor laser devices and traveled via the prism 13.

The first regions 21 are in the shape of rectangles that extend in the X direction, arranged substantially at the both end portions in the Y direction on the incident face 14a, that is, around edges of the incident face 14a. When the incident face 14a is viewed from one side in the incident direction, a height d1 in parallel with the Y direction of the first region 21 is determined to be half the size obtained by deducting, from a height H of the erecting mirror 14, a diameter R of a region (hereinafter, referred to as an “effective beam region”) 26 of a light beam that effectively enters the objective lens 15, the region being projected on the incident face 14a on the erecting mirror 14.

The second region 22 is disposed on the remaining portion obtained by eliminating the first regions 21 from the incident face 14a. In other words, the second region 22 is in the shape of a rectangle that extends in the X direction, disposed between one end portion in the Y direction and the other end portion in the Y direction on the incident face 14a. The height in parallel with the Y direction of the second region 22 is determined to be the diameter R of the effective beam region 26.

FIG. 2 shows a region (hereinafter, referred to as a “reference effective beam region”) 26a of a light beam that effectively enters the objective lens 15 when the objective lens 15 is positioned at a predetermined reference position, the region being projected on the incident face 14a, an effective beam region (hereinafter, referred to as “one side effective beam region”) 26b at a position most significantly displaced to one side in the X direction on the incident face 14a obtained when the objective lens 15 is most significantly moved to one side in a track direction Tr (described later), the region being projected on the incident face 14a, and an effective beam region (hereinafter, referred to as the “other side effective beam region”) 26c at a position most significantly displaced to the other side in the X direction on the incident face 14a obtained when the objective lens 15 is most significantly moved to the other side in the track direction Tr (described later), the region being projected on the incident face 14a. In this embodiment, the reference effective beam region 26a, the one side effective beam region 26b, and the other side effective beam region 26c are collectively referred an “effective beam region 26”.

Of the light beam which is emitted from the second semiconductor laser device, traveled via the prism 13, and enters the incident face 14a on the erecting mirror 14, the light beam entering the first regions 21 is transmitted through the erecting mirror 14 as indicated by the arrows A in FIG. 3, and the light beam entering the second region 22 is reflected to enter the incident face 14a on the objective lens 15, and is focused on the information recording surface of the CD 18a.

Of the light beam which is reflected by the information recording surface of the CD 18a, traveled via the objective lens 15, and enters the incident face 14a on the erecting mirror 14, the light beam entering the first regions 21 is transmitted through the erecting mirror 14, and the light beam entering the second region 22 on the incident face 14a is reflected and guided to the prism 13.

As described above, according to this embodiment, the erecting mirror 14 is provided on the optical path between the light source 11 and the objective lens 15. The incident face 14a on the erecting mirror 14 is provided with the wavelength selective film having the first regions 21 that reflect a light beam having the first wavelength emitted from the first semiconductor laser device and that transmit a light beam having the second wavelength emitted from the second semiconductor laser device, and the second region 22 that reflects light beams emitted from the first and the second semiconductor laser devices. Accordingly, it is possible to guide only a light beam entering the second region 22 to the objective lens 15 by reflecting the light beam and by transmitting a light beam which enters the first regions 21, of the light beam having the second wavelength emitted from the second semiconductor laser device and enters the incident face 14a on the erecting mirror 14.

In other words, by providing the wavelength selective film on the incident face 14a on the erecting mirror 14, the beam diameter of a light beam having the second wavelength emitted from the second semiconductor laser device can be limited to a predetermined size, that is, a size that enables adjustment for a numerical aperture appropriate for focusing the light beam having the second wavelength on the information recording surface of the CD 18a, before the light beam having the second wavelength enters the objective lens 15. Thus, the light beam having the second wavelength whose beam diameter has been limited to the predetermined size can enter the objective lens 15.

Thus, the numerical aperture of the objective lens 15 can be adjusted to a numerical aperture appropriate for focusing the light beam having the second wavelength on the information recording surface of the CD 18a. Accordingly, it is possible to reduce the amount of flare light generated when a light beam having the second wavelength travels via the objective lens 15, compared with the conventional techniques in which the light beam having the second wavelength whose beam diameter has not been limited to a predetermined size enters the objective lens 15.

Thus, flare light generated at the objective lens 15 is less reflected by the CD 18a to enter the photodetector 17 as stray light other than signal light. Accordingly, it is possible to suppress an error caused by stray light, in a detection signal for reading and recording information from/onto the CD 18a, compared with the conventional techniques in which the light beam having the second wavelength whose beam diameter has not been limited to a predetermined size enters the objective lens 15.

Furthermore, according to this embodiment, the wavelength selective film serving as the wavelength selective optical element is provided on the incident face 14a on the erecting mirror 14 which a light beam emitted from the light source 11 enters. Thus, a light beam entering the wavelength selective film is reflected or transmitted depending on the oscillation wavelength thereof, so that, for example, the beam diameter of the light beam having the second wavelength emitted from the light source 11 can be limited to a predetermined size, before the light beam having the second wavelength enters the objective lens 15. Thus, it is possible to prevent the number of optical components from being increased and to prevent the production cost of the optical pickup apparatus 10 from being increased, compared with the conventional techniques in which an optical component such as a filter used only for limiting the beam diameter of the light beam having the second wavelength to a predetermined size is provided in addition to the erecting mirror 14.

Furthermore, according to this embodiment, it is not necessary to provide an optical component such as a filter on the optical path between the erecting mirror 14 and the objective lens 15. Accordingly, it is possible to make the optical pickup apparatus 10 thinner and smaller in the direction in which a light beam is directed from the erecting mirror 14 to the optical recording medium 18, compared with the conventional techniques in which it is necessary to provide an optical component such as a filter on the optical path between the erecting mirror 14 and the objective lens 15.

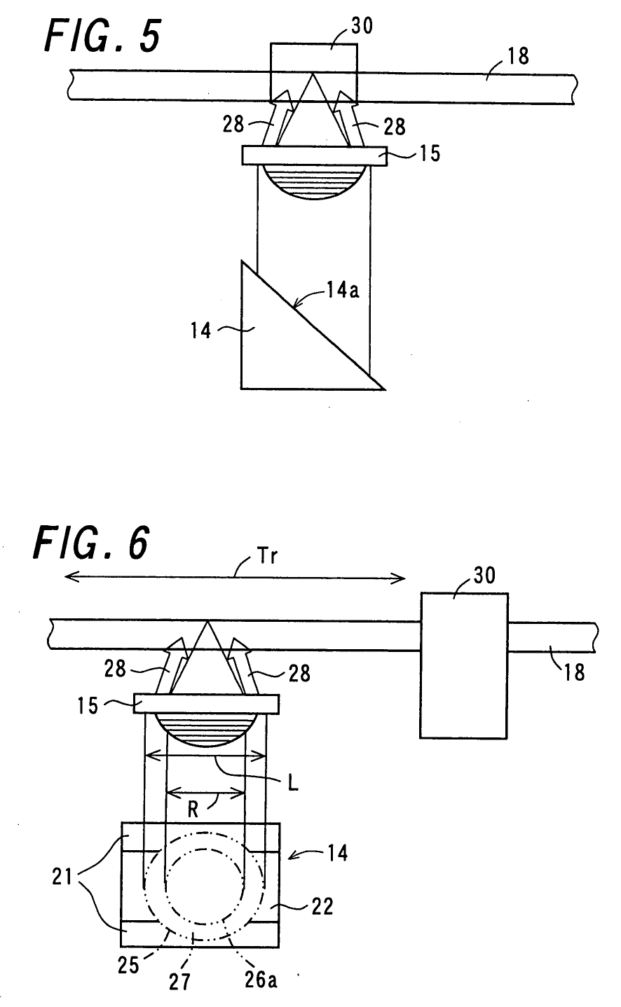

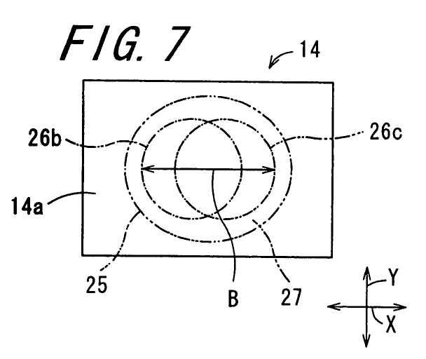

FIG. 5 is a view showing a state in which a light beam traveled via the erecting mirror 14 and the objective lens 15 is focused on the optical recording medium 18. FIG. 6 is an end face view of FIG. 5, viewed from the direction in which a light beam directed to the optical recording medium 18 enters the erecting mirror 14. FIG. 7 is a view showing an incident beam region 25, the one side effective beam region 26b, and the other side effective beam region 26c.

FIG. 6 shows the incident beam region 25 in which a light beam emitted from the first and the second semiconductor laser devices enters the erecting mirror 14 and the objective lens 15, and the reference effective beam region 26a. FIG. 7 shows the incident beam region 25, the one side effective beam region 26b, and the other side effective beam region 26c. The incident beam region 25, the reference effective beam region 26a, the one side effective beam region 26b, and the other side effective beam region 26c are each substantially in the shape of a circle. The reference effective beam region 26a, the one side effective beam region 26b, and the other side effective beam region 26c are each a region that is smaller than the incident beam region 25. In other words, an effective beam diameter R indicating the diameter of the reference effective beam region 26a is smaller than an incident beam diameter L indicating the diameter of the incident beam region.

A light beam traveled via a remaining region (hereinafter, referred to as an “outer beam region”) 27 obtained by eliminating the reference effective beam region 26a from the incident beam region 25, on the objective lens 15, is diffracted by a diffracting action of the diffraction grooves formed on the objective lens 15, and is removed by being scattered as flare light 28, which is unwanted light for reading or recording information from/onto the optical recording medium 18.

The optical pickup apparatus 10 is configured so as to read information recorded on the optical recording medium 18 that is attached to a spindle portion 30, by performing tracking servo control in which the positional relationship between beam spots of laser beams emitted from the semiconductor laser devices and tracks on the information recording surface of the optical recording medium 18 such that the beam spots follows the tracks, by moving the objective lens 15 in the radial direction of the optical recording medium 18.

The objective lens 15 can be driven by an actuator (not shown) to move in a focus direction, which is the optical axis direction of the objective lens 15, and in a track direction in parallel with the radial direction of the optical recording medium 18. Accordingly, during the tracking servo control, the objective lens 15 attached to the actuator is driven to slightly move in the track direction Tr and is displaced from the predetermined reference position.

The optical pickup apparatus 10 is mounted on an information recording/reproduction apparatus (described later), and the optical pickup apparatus 10 itself also is driven to move in the track direction Tr. Accordingly, the objective lens 15 may be significantly displaced in the track direction Tr by inertia, as the optical pickup apparatus 10 is driven to move in the track direction Tr. When the objective lens 15 is displaced in the track direction Tr, the effective beam region 26 is also displaced from a predetermined reference position in the track direction Tr, that is, in the direction indicated by the arrow B in FIG. 7, within the incident beam region 25.

A light beam entering the second region 22 on the wavelength selective film provided on the incident face 14a on the erecting mirror 14 when the objective lens 15 is positioned at the center of a track is originally to be used as a light beam of the effective beam region 26, which is necessary for reading and recording information from/onto the optical recording medium 18. When the objective lens 15 is displaced from the predetermined reference position in the track direction Tr, the effective beam region 26 including a light beam used for reading and recording information from/onto the optical recording medium 18 is displaced in the track direction Tr.

As the objective lens 15 is displaced in the track direction Tr, the reference effective beam region 26a is displaced to the one side effective beam region 26b or the other side effective beam region 26c. In this embodiment, considering the fact that the reference effective beam region 26a is displaced in the track direction Tr, the second region 22 in the shape of a rectangle that extends in the X direction is disposed between one end portion in the Y direction and the other end portion in the Y direction on the incident face 14a, and the first regions 21 in the shape of rectangles that extend in the X direction are arranged substantially at the both end portions in the Y direction on the incident face 14a, as shown in FIG. 2.

However, the foregoing embodiment does not provide a configuration for limiting the beam diameter in the track direction Tr of a light beam entering the second region 22 on the wavelength selective film provided on the incident face 14a on the erecting mirror 14. Thus, the flare light 28 is generated from the light beam on the outer beam region 27, of the light beam on the incident beam region 25, reflected by the second region 22 shown in FIG. 2 and enters the objective lens 15. In order to further reduce the amount of the flare light 28 generated at this objective lens 15, it is necessary to set the positions of the first regions 21 and the second region 22 on the incident face 14a on the erecting mirror 14, based on the movable range of the objective lens 15 in the track direction Tr and the predetermined reference position of the objective lens 15.

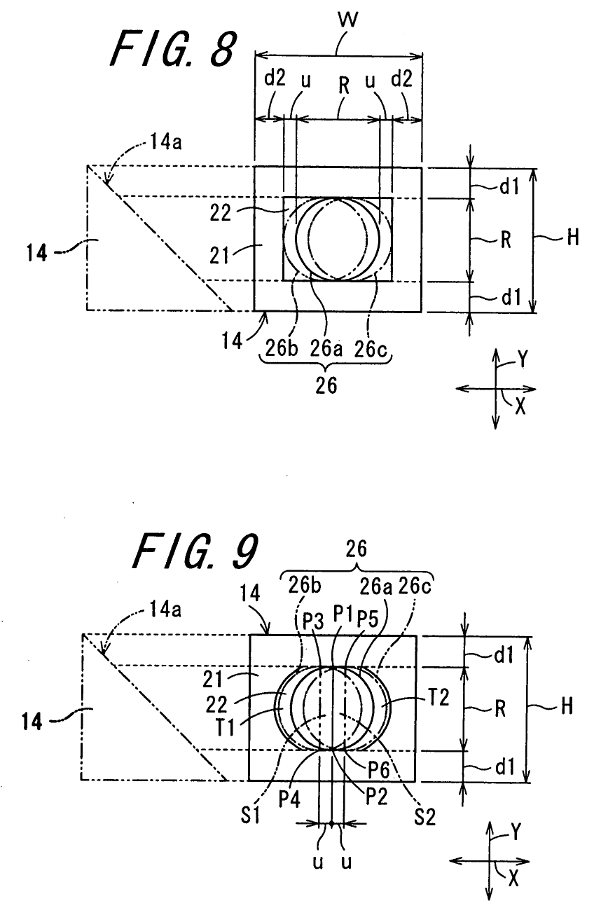

FIG. 8 is an end face view showing the incident face 14a on the erecting mirror 14 in an optical pickup apparatus according to another embodiment of the invention. In this embodiment, considering the fact that the reference effective beam region 26a is displaced to the one side effective beam region 26b or the other side effective beam region 26c as the objective lens 15 is displaced in the track direction Tr, the position, the shape, and the like of the first region 21 and the second region 22 on the wavelength selective film provided on the incident face 14a on the erecting mirror 14 are determined based on the movable range of the objective lens 15 and the predetermined reference position of the objective lens 15.

More specifically, as shown in FIG. 8, the second region 22 of this embodiment is in the shape of a rectangle that extends in the X direction, disposed at a substantially center position on the incident face 14a. The second region 22 is disposed such that a predetermined space d1 is interposed in the Y direction between the outer edge portion on one side in the Y direction on the second region 22 and one end portion in the Y direction on the incident face 14a, and such that the predetermined space d1 is interposed in the Y direction between the outer edge portion on the other side in the Y direction on the second region 22 and the other end portion in the Y direction on the incident face 14a. Furthermore, the second region 22 is disposed such that a predetermined space d2 is interposed in the X direction between the outer edge portion on one side in the X direction, which is an edge in parallel with the Y direction on the second region 22, and one end portion in the X direction on the incident face 14a, and such that the predetermined space d2 is interposed in the X direction between the outer edge portion on the other side in the X direction, which is an edge in parallel with the Y direction on the second region 22, and the other end portion in the X direction on the incident face 14a.

Herein, when the incident face 14a is viewed from one side in the incident direction, the predetermined space d1 is determined to be half the size obtained by deducting, from the height H of the erecting mirror 14, the diameter R of the effective beam region 26 projected on the incident face 14a on the erecting mirror 14.

When the incident face 14a is viewed from one side in the incident direction, the predetermined space d2 is determined to be half the size obtained by deducting, from a width W in parallel with the X direction of the erecting mirror 14, the total of the diameter R of the effective beam region 26 and the size obtained by doubling a maximum displacement width u in the track direction Tr of the reference effective beam region 26a based on the displacement of the objective lens 15 in the track direction Tr. The first region 21 is disposed so as to enclose the second region 22, on the remaining portion obtained by eliminating the second region 22 from the incident face 14a.

As described above, according to this embodiment, the length in the X direction of the second region 22 on the wavelength selective film on the erecting mirror 14 is made smaller than the length in the X direction of the second region 22 on the wavelength selective film on the erecting mirror 14 shown in FIG. 2, based on the movable range of the objective lens 15 in the track direction Tr and the predetermined reference position of the objective lens 15. Accordingly, the beam diameter in the X direction of a light beam entering the second region 22 on the wavelength selective film on the erecting mirror 14 can be limited, and thus the beam diameter in the track direction Tr of a light beam entering the objective lens 15 can be limited.

In this manner, according to this embodiment, the light beam whose beam diameter in the X direction has been limited can enter the objective lens 15, and thus it is possible to make the outer beam region 27 in the incident beam region 25 on the objective lens 15 smaller and to reduce the amount of a light beam in the outer beam region 27, compared with the optical pickup apparatus provided with the erecting mirror 14 shown in FIG. 2 in which beam diameter in the X direction is not limited. Accordingly, it is possible to reduce the amount of flare light generated from a light beam in the outer beam region 27, compared with the optical pickup apparatus provided with the erecting mirror 14 shown in FIG. 2.

Thus, flare light generated at the objective lens 15 is even less reflected by the optical recording medium 18 to enter the photodetector 17 as stray light other than signal light. Accordingly, it is possible to further suppress an error caused by stray light, in a detection signal for reading and recording information from/onto the optical recording medium 18, compared with the optical pickup apparatus provided with the erecting mirror 14 shown in FIG. 2 in which beam diameter in the X direction is not limited.

FIG. 9 is an end face view showing the incident face 14a on the erecting mirror 14 in an optical pickup apparatus according to still another embodiment of the invention. In this embodiment, considering the fact that the reference effective beam region 26a is displaced to the one side effective beam region 26b or the other side effective beam region 26c as the objective lens 15 is displaced in the track direction Tr, the position, the shape, and the like of the first region 21 and the second region 22 on the wavelength selective film provided on the incident face 14a on the erecting mirror 14 are determined based on the movable range of the objective lens 15 and the predetermined reference position of the objective lens 15.

More specifically, as shown in FIG. 9, the second region 22 in this embodiment is substantially in the shape of a rectangle that extends in the X direction. The intersecting points of an axial line passing through the center of the reference effective beam region 26a and extending in parallel with the Y direction, with the outermost edge portions on one side and the other side in the Y direction of the reference effective beam region 26a are respectively taken as P1 and P2. The intersecting points of an axial line passing through the center of the one side effective beam region 26b and extending in parallel with the Y direction, with the outermost edge portions on the one side and the other side in the Y direction of the one side effective beam region 26b are respectively taken as P3 and P4. The intersecting points of an axial line passing through the center of the other side effective beam region 26c and extending in parallel with the Y direction, with the outermost edge portions on the one side and the other side in the Y direction of the other side effective beam region 26c are respectively taken as P5 and P6.

A rectangular region that is enclosed by a line segment P1P2 connecting between the point P1 and the point P2, a line segment P1P3 connecting between the point P1 and the point P3, a line segment P3P4 connecting between the point P3 and the point P4, and a line segment P2P4 connecting between the point P2 and the point P4 is taken as S1. A rectangular region that is enclosed by the line segment P1P2, a line segment P5P6 connecting between the point P5 and the point P6, a line segment P1P5 connecting between the point P1 and the point P5, and a line segment P2P6 connecting between the point P2 and the point P6 is taken as S2.

The length of the line segment P1P2 corresponds to the diameter R of the reference effective beam region 26a, the length of the line segment P3P4 corresponds to the diameter R of the one side effective beam region 26b, and the line segment P5P6 corresponds to the diameter R of the other side effective beam region 26c. Each of the lengths of the line segment P1P3, the line segment P2P4, the line segment P1P5, and the line segment P2P6 corresponds to the maximum displacement width u in the track direction Tr of the reference effective beam region 26a, based on the displacement of the objective lens 15 in the track direction Tr.

In the one side effective beam region 26b, a semi-circular region on the one side in the X direction with respect to the line segment P3P4 is taken as T1. In the other side effective beam region 26c, a semi-circular region on the other side in the X direction with respect to the line segment P5P6 is taken as T2.

The second region 22 is a region obtained by connecting the region T1 to the one side in the X direction on the region S1, connecting the region S2 to the other side in the X direction on the region S1, and connecting the region T2 to the other side in the X direction on the region S2. In other words, the second region 22 has a shape in which a rectangle that is enclosed by the line segment P3P4, the line segment P5P6, a line segment P3P5 connecting between the point P3 and the point P5, and a line segment P4P6 connecting between the point P4 and the point P6 is held from the both sides in the X direction by semi-circles having a radius of R/2.

More specifically, the second region 22 is disposed such that the outer edge portion on the one side in the X direction on the second region 22 is along the outer edge portion on the one side in the X direction on the one side effective beam region 26b, and such that the outer edge portion on the other side in the X direction on the second region 22 is along the outer edge portion on the other side in the X direction on the other side effective beam region 26c. The first region 21 is disposed so as to enclose the second region 22, on the remaining portion obtained by eliminating the second region 22 from the incident face 14a.

Furthermore, the second region 22 is disposed such that a predetermined space d1 is interposed in the Y direction between the outer edge portion on the one side in the Y direction on the second region 22 and one end portion in the Y direction on the incident face 14a, and such that the predetermined space d1 is interposed in the Y direction between the outer edge portion on the other side in the Y direction on the second region 22 and the other end portion in the Y direction on the incident face 14a. Herein, when the incident face 14a is viewed from one side in the incident direction, the predetermined space d1 is determined to be half the size obtained by deducting, from the height H of the erecting mirror 14, the diameter R of the effective beam region 26 projected on the incident face 14a on the erecting mirror 14.

As described above, according to this embodiment, the length in the X direction of the second region 22 at the both end portions in the Y direction is made smaller than the length in the X direction of the second region 22 at the both end portions in the Y direction on the erecting mirror 14 shown in FIG. 8, by providing the second region 22 on the erecting mirror 14 with a shape in which a rectangle is held by semi-circles, based on the movable range of the objective lens 15 in the track direction Tr and the predetermined reference position of the objective lens 15. Accordingly, the beam diameter in the X direction of a light beam entering the second region 22 on the erecting mirror 14 can be limited, and thus the beam diameter in the track direction Tr of a light beam entering the objective lens 15 can be limited.

In this manner, according to this embodiment, a light beam whose beam diameter in the X direction has been further limited can enter the objective lens 15, compared with the optical pickup apparatus provided with the erecting mirror 14 shown in FIG. 8, and thus it is possible to make the outer beam region 27 in the incident beam region 25 on the objective lens 15 even smaller and to further reduce the amount of a light beam in the outer beam region 27. Accordingly, it is possible to further reduce the amount of flare light generated from a light beam in the outer beam region 27, compared with the optical pickup apparatus provided with the erecting mirror 14 shown in FIG. 8.

Thus, flare light generated at the objective lens 15 is even less reflected by the optical recording medium 18 to enter the photodetector 17 as stray light other than signal light. Accordingly, it is possible to further suppress an error caused by stray light, in a detection signal for reading and recording information from/onto the optical recording medium 18, compared with the optical pickup apparatus provided with the erecting mirror 14 shown in FIG. 8.

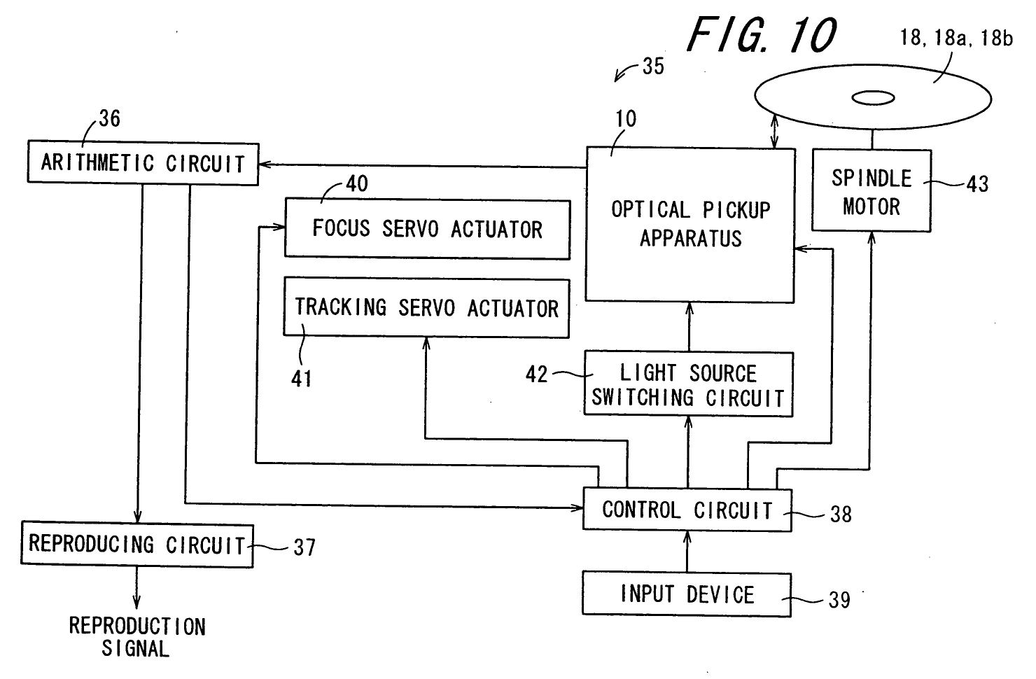

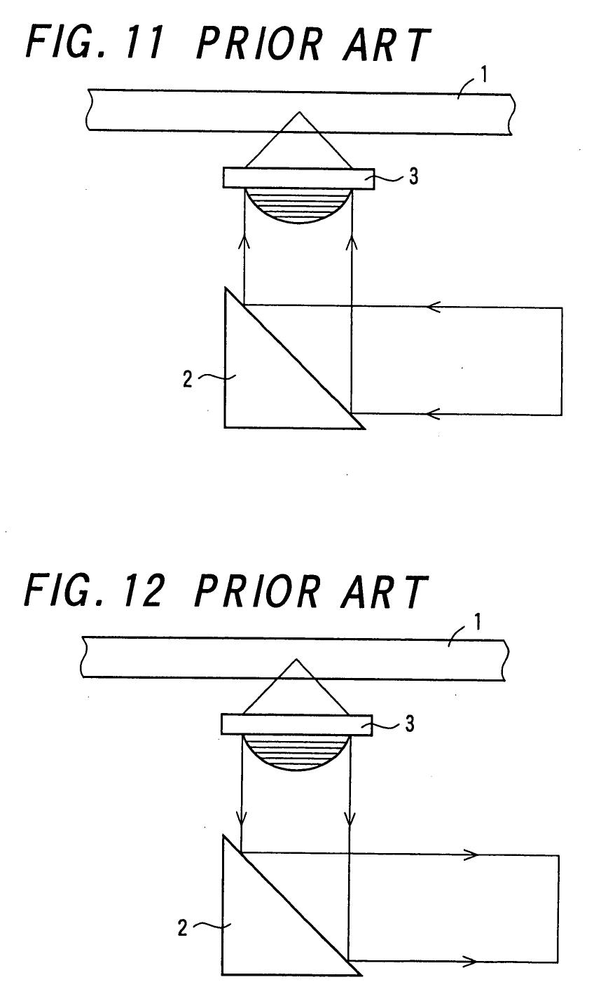

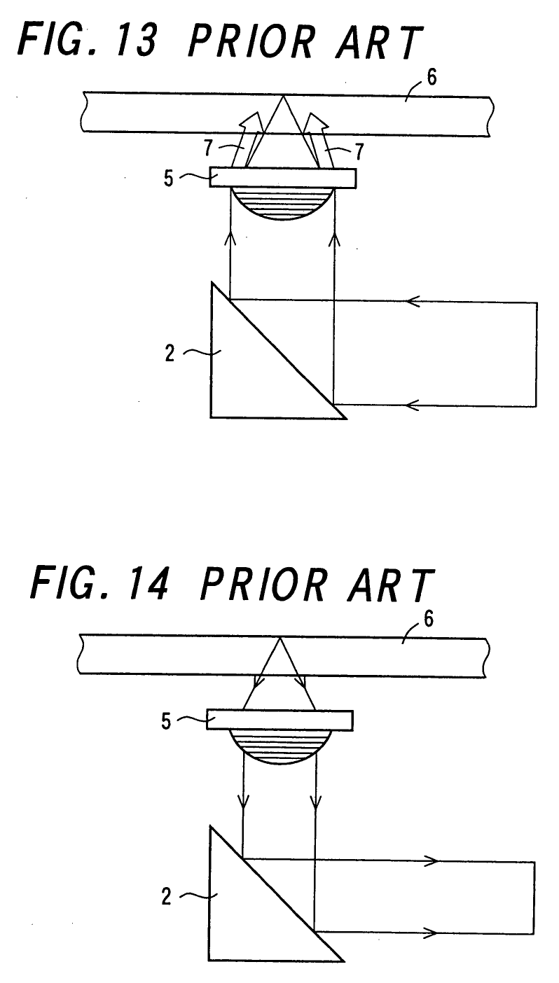

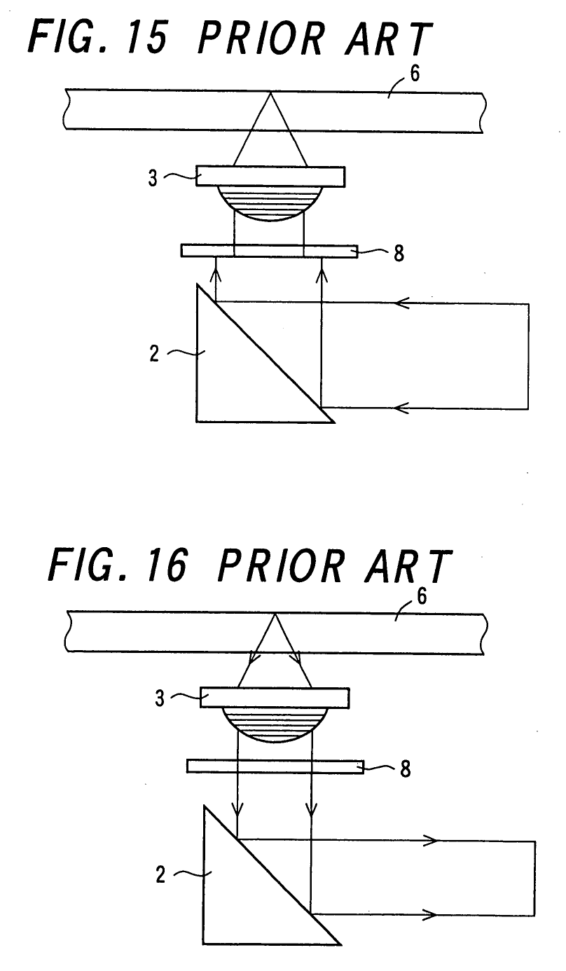

FIG. 10 is a block diagram showing the configuration of an information recording/reproduction apparatus 35. The information recording/reproduction apparatus 35 can record information onto the optical recording medium 18 such as the CD 18a and a DVD 18b, and reproduce information recorded on the optical recording medium 18. The information recording/reproduction apparatus 35 includes the optical pickup apparatus 10, an arithmetic circuit portion 36, a reproducing circuit portion 37, a control circuit portion 38, an input device 39, a focus servo actuator 40, a tracking servo actuator 41, a light source switching circuit portion 42, and a spindle motor 43.

In the optical pickup apparatus 10, a laser beam emitted from the light source 11 that has been switched by the light source switching circuit portion 42 based on a command from the control circuit portion 38 travels via the collimator lens 12, the prism 13, the erecting mirror 14, and the objective lens 15, and is focused on the information recording surface of the optical recording medium 18. Then, the light reflected by the information recording surface of the optical recording medium 18 is received by predetermined light-receiving regions of the photodetector 17, and signals that have been output from the light-receiving regions are output as PD output signals to the arithmetic circuit portion 36.

Based on the PD output signals given from the optical pickup apparatus 10, the arithmetic circuit portion 36 generates data detection signals for reproducing information recorded on the optical recording medium 18, and outputs the generated data detection signals to the reproducing circuit portion 37. Furthermore, the arithmetic circuit portion 36 detects a focus error signal (hereinafter, maybe referred to as an “FES”) using the astigmatism, and detects a tracking error signal (hereinafter, may be referred to as a “TES”) using the phase difference or the like. Then, the arithmetic circuit portion 36 outputs the FES and the TES to the control circuit potion 38.

Data detection signals that are output from the arithmetic circuit portion 36 are equalized and then converted into digital signals by the reproducing circuit portion 37. The reproducing circuit portion 37 performs an error correcting process and the like, demodulates the signals, and outputs the demodulated signals as reproduction signals to an external output device such as a loudspeaker.

The control circuit portion 38 performs focus servo control in which the focus position of a beam spot of a laser beam is adjusted such that the beam spot is focused on the information recording surface of the optical recording medium 18, by controlling the focus servo actuator 40 based on the FES that has been output from the arithmetic circuit portion 36, thereby moving the objective lens 15 in the optical pickup apparatus 10.

Furthermore, the control circuit portion 38 performs tracking servo control in which the positional relationship between a beam spot of a laser beam and tracks on the information recording surface of the optical recording medium 18 such that the beam spot follows the tracks, by controlling the tracking servo actuator 41 based on the TES that has been output from the arithmetic circuit portion 36, thereby moving the objective lens 15 in the optical pickup apparatus 10 in the radial direction of the optical recording medium 18.

Furthermore, the control circuit portion 38 generates the first laser beam from the first semiconductor laser device when reproducing the DVD 18b, and generates the second laser beam from the second semiconductor laser device when reproducing the CD 18a, by controlling the light source switching circuit portion 42 based on a command that has been input from the input device 39. The control circuit portion 38 rotates the CD 18a and the DVD 18b at a predetermined speed, by controlling the spindle motor 43.

When the optical pickup apparatus 10 of the foregoing embodiments is mounted on the information recording/reproduction apparatus 35, it is possible to realize the information recording/reproduction apparatus 35 that can suppress an error caused by stray light, in a detection signal for reading and recording information from/onto the optical recording medium 18.

The foregoing embodiments are no more than examples of the invention, and the configuration can be changed within the scope of the invention. For example, the shape of the erecting mirror 14 is not limited to a triangular prism, and may be other shapes such as a flat plate, as long as the first region and the second region can be arranged on the erecting mirror 14. Even when the erecting mirror 14 is in the shape of a flat plate, it is possible to achieve a similar effect as in the foregoing embodiments.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. An optical pickup apparatus, comprising:
a light source for emitting light beams having oscillation wavelengths different from each other;
an objective lens for focusing each light beam emitted from the light source on an optical recording medium corresponding to the light beam;
a wavelength selective optical element provided on an optical path between the light source and the objective lens, for reflecting or transmitting an incident light beam depending on an oscillation wavelength thereof, and for guiding the reflected light beam to the objective lens; and
a photodetector for detecting a light beam that is emitted from the light source and reflected by an information recording surface of the optical recording medium,
wherein the wavelength selective optical element has a first region that reflects a light beam having the first oscillation wavelength emitted from the light source and that transmits a light beam having the second oscillation wavelength, and a second region that reflects the light beams emitted from the light source.

2. The optical pickup apparatus of claim 1, wherein positions of the first and the second regions on the wavelength selective optical element are set based on a movable range of the objective lens in a direction that corresponds to a track direction of the optical recording medium, and a predetermined reference position of the objective lens.

3. The optical pickup apparatus of claim 1, further comprising an erecting mirror which a light beam emitted from the light source enters,
wherein the wavelength selective optical element is constituted by a wavelength selective film disposed on a surface of the erecting mirror, for reflecting or transmitting an incident light beam depending on an oscillation wavelength thereof.

4. The optical pickup apparatus of claim 3, wherein the first region is disposed around edges of the surface of the erecting mirror.

5. The optical pickup apparatus of claim 3, wherein the first region is disposed to surround the second region.

6. An information recording/reproduction apparatus on which the optical pickup apparatus of claim 1 is mounted.
